(19) United States
(12) Patent Application Publication
(10) Pub. No.: US 2006/0193314 A1
(43) Pub. Date: Aug. 31, 2006

(54) Broadcast router optimized for asymmetrical confirguration

(76) Inventor: Carl Christensen, South Jordan, UT (US)

Correspondence Address: Joesph S Tripoli;Thomson Licensing Inc, PO Box 5312, Princeton, NJ, 08543-5312, US

(21) Appl. No.: 10/566,568

(22) PCT Filed: Mar. 4, 2004
(86) PCT No.: PCT/US04/06568

§ 371 Date: Jan. 31, 2006

Related U.S. Application Data
(60) Provisional application No. 60/495,655, filed on Aug. 15, 2003.

(51) Int. Cl. H04Q 11/00; H04L 12/28; H04L 12/50; H04L 12/56

(52) U.S. Cl. 370/386; 370/389

(57) ABSTRACT

There is provided a broadcast router. The broadcast router includes at least one input chassis and at least one output chassis. Each of the input chassis has a plurality of input cards and an expansion card. The plurality of input cards is for initially receiving data into the broadcast router. The expansion card is for respectively receiving the data from the plurality of input cards and arranging the data for transfer within the broadcast router. Each of the output chassis has a matrix card and a plurality of output cards. The matrix card is for receiving the data from all of the at least one input chassis and for routing the data to appropriate ones of the plurality of output cards. The plurality of output cards is for respectively receiving the data from the matrix card and for outputting the data external to the broadcast router. Each of the input chassis is without any output cards including the plurality of output cards, and each of the output chassis is without any input cards including the plurality of input cards.

### BACKGROUND OF THE INVENTION

1. Field of the Invention

The present invention generally relates to routers and, more particularly, to a broadcast router optimized for an asymmetrical configuration.

2. Background of the Invention

A broadcast router allows each one of a plurality of outputs there from to be assigned a signal from any one of a plurality of inputs thereto. For example, an N×M broadcast router has N inputs and M outputs coupled together by a routing engine that allows any one of the N inputs to be applied to each one of the M outputs.

In conventional linearly expandable broadcast router architectures, each chassis includes both input cards and output cards and is usually designed to support the same number of outputs and inputs per chassis.

However, in some cases, the ratio of inputs to outputs varies significantly from the usual one-to-one relationship. Accordingly, it would be desirable and highly advantageous to have a broadcast router that is optimized for an asymmetrical configuration.

### SUMMARY OF THE INVENTION

The problems stated above, as well as other related problems of the prior art, are solved by the present invention, a broadcast router that is optimized for an asymmetrical configuration.

According to an aspect of the present invention, there is provided a broadcast router. The broadcast router includes at least one input chassis and at least one output chassis. Each of the input chassis has a plurality of input cards and an expansion card. The plurality of input cards is for initially receiving data into the broadcast router. The expansion card is for respectively receiving the data from the plurality of input cards and arranging the data for transfer within the broadcast router. Each of the output chassis has a matrix card and a plurality of output cards. The matrix card is for receiving the data from all of the at least one input chassis and for routing the data to appropriate ones of the plurality of output cards. The plurality of output cards is for respectively receiving the data from the matrix card and for outputting the data external to the broadcast router. Each of the input chassis is without any output cards including the plurality of output cards, and each of the output chassis is without any input cards including the plurality of input cards.

According to another illustrative embodiment of the present invention, there is provided a broadcast router. The broadcast router includes at least one input chassis, at least one output chassis, and a control card. Each of the input chassis has a plurality of input cards and an expansion card. The plurality of input cards is for receiving and conditioning data. The expansion card is for respectively receiving the data from the plurality of input cards and arranging the data using time division multiplexing for transfer within the broadcast router. Each of the output chassis has a matrix card and a plurality of output cards. The matrix card is for receiving the data from all of the at least one input chassis and for routing the data to appropriate ones of the plurality of output cards. The plurality of output cards is for respectively receiving the data from the matrix card and for outputting the data external to the broadcast router. The control card is disposed within at least one of the at least one input chassis and the at least one output chassis, and is for providing support protocols to change input/output assignments of the data. The number of inputs to the input chassis is different than a number of outputs from the output chassis. Each of the input chassis is without any output cards including the plurality of output cards, and each of the output chassis is without any input cards including the plurality of input cards.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a diagram illustrating a linearly expandable broadcast router 400, according to an illustrative embodiment of the present invention;

FIG. 2 is a diagram illustrating a broadcast router architecture 200 that is configured with the same number of inputs and outputs, according to an illustrative embodiment of the present invention;

FIG. 3 is a diagram illustrating a broadcast router architecture 300 that is configured with many more inputs than outputs, according to another illustrative embodiment of the present invention; and

FIG. 4 is a diagram illustrating a broadcast router architecture 500 that is configured with many more outputs than inputs, according to yet another illustrative embodiment of the present invention.

### DETAILED DESCRIPTION OF THE INVENTION

The present invention is directed to a broadcast router that is optimized for an asymmetrical configuration. Thus, the present invention may be advantageously employed when the ratio of inputs to outputs varies from the usual one-to-one relationship. Moreover, the present invention is beneficial when constructing very large routers (e.g., routers have an input to output ratio greater than 1024×1024).

It is to be appreciated that a broadcast router in accordance with the present invention may be employed with respect to any type of signal, including, but not limited to, digital audio, digital video, serial/RS422 data streams, compressed video streams, and so forth.

It is to be further appreciated that while the present invention is particularly suited for an asymmetrical configuration (i.e., N≠M), the present invention may nonetheless be employed for use in symmetrical configurations, thus providing flexibility to meet any given application.

It is to be understood that the present invention may be implemented in various forms of hardware, software, firmware, special purpose processors, or a combination thereof. Preferably, the present invention is implemented as a combination of hardware and software.

It is to be further understood that, because some of the constituent system components depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

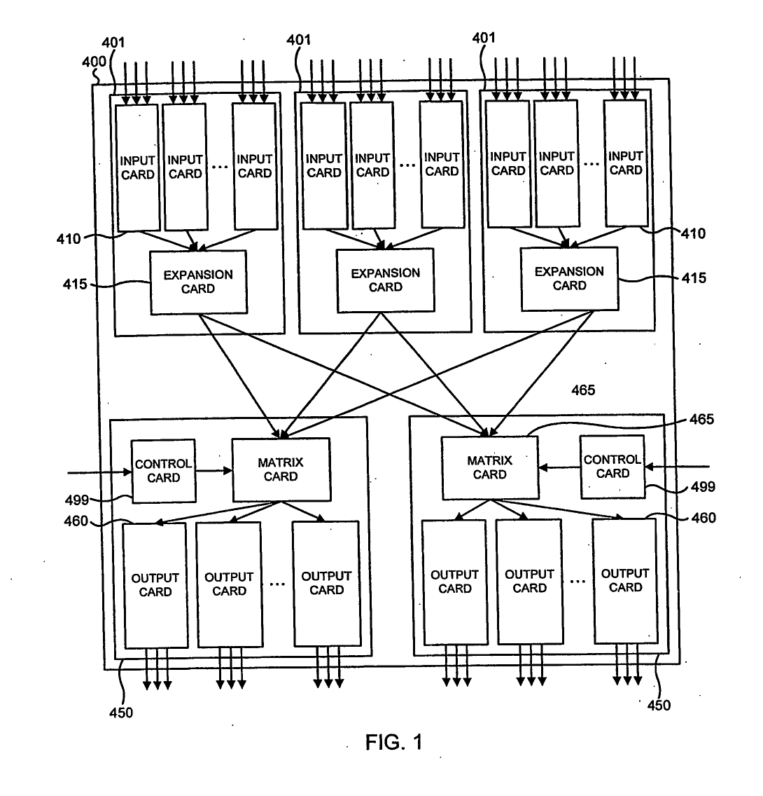

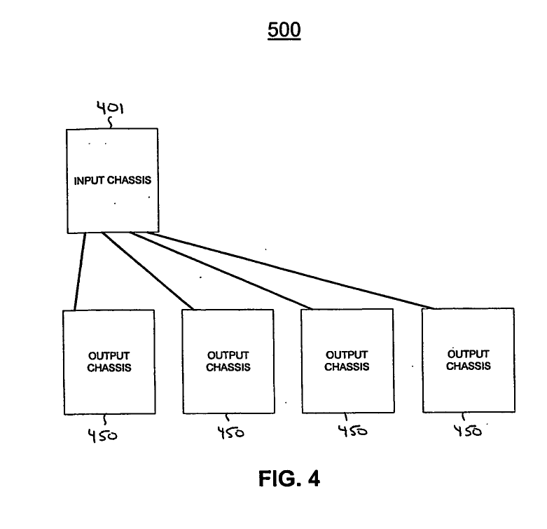

FIG. 1 is a diagram illustrating a linearly expandable broadcast router 400, according to an illustrative embodiment of the present invention. The broadcast router 400 includes three input chassis 401 and two output chassis 450. It is to be appreciated while the broadcast router 400 of FIG. 4 is shown and described with respect to three input chassis and two output chassis, a broadcast router in accordance with the present invention may be have number of input chassis and any number of output chassis, while maintaining the spirit of the present invention. The use of multiple input and output chassis in accordance with the present invention allows for the linear expansion of the broadcast router.

Each of the input chassis 401 includes a plurality of input cards (hereinafter “input cards”) 410 and an expansion card 415.

The input cards 410 receive input streams and “condition” the input streams for transmission through the broadcast router 400. The types of signal conditioning operations to be performed on the input stream will vary depending on the signal type to be conditioned. For example, some of the types of signal conditioning that may be employed include, but are not limited to, decoding, re-clocking, amplitude amplification, and so forth.

The expansion card 415 receives the streams from the input cards 410 and arranges the streams in time division multiplexed streams for transmission to the output chassis 450. It is to be appreciated that the present invention is not limited to time division multiplexing by the expansion card to arrange the streams and, thus, other data arranging schemes may also be employed while maintaining the spirit of the present invention.

Each of the output chassis 450 includes a plurality of output cards (hereinafter “output cards”) 460 and a matrix card 465.

The matrix card 465 receives the time-multiplexed streams from the input chassis and routes the streams to the appropriate output cards 460.

The output cards 460 receive the streams from the matrix card 465 and prepare the streams for transmission on the outputs of the broadcast router 400. Preparation of the streams may involve signal conditioning, conversation of the data within parameters of a pre-specified protocol, and so forth.

In the illustrative embodiment of FIG. 4, a control card 499 is shown and described with respect to the output chassis 401. However, it is to be appreciated that the control card may be employed with respect to the input chassis 401 and/or the output chassis 450.

The control card 499 interfaces support protocols with the input chassis 401 (and/or the output chassis 450) for changing the input/output assignments of the broadcast router 400. It is to be appreciated that the functions performed by the control card 499 may be optionally subsumed by and integrated with the expansion card 415 and/or the matrix card 465, depending upon whether the control card 499 is implemented within the input chassis 401 and/or the output chassis 450, respectively.

For each input chassis 401, the input cards 410 of that input chassis 401 receive and decode a number of incoming input streams (hereinafter “data”), and then output the data to the expansion card 415. For each input chassis 401, the expansion card 415 of that input chassis 401 receives all of the data from all of the input cards 410 and transfers the data to all of the output chassis 450.

For each output chassis 450, the matrix card 465 receives the data from all of the input chassis 401 and routes the data to the output cards 460. The output cards 460 recreate the associated input stream that was input to the broadcast router 400 on the outputs of the broadcast router 400.

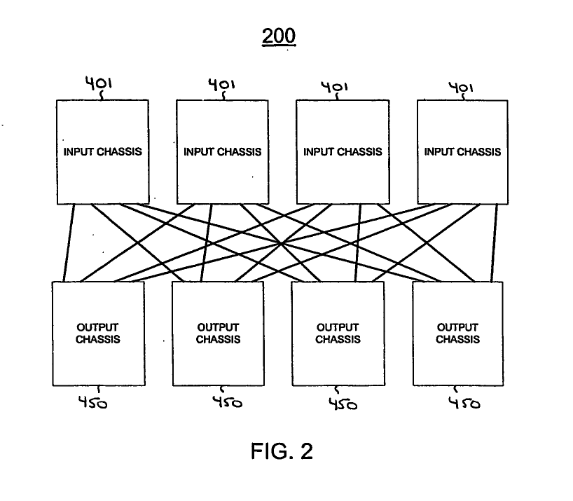

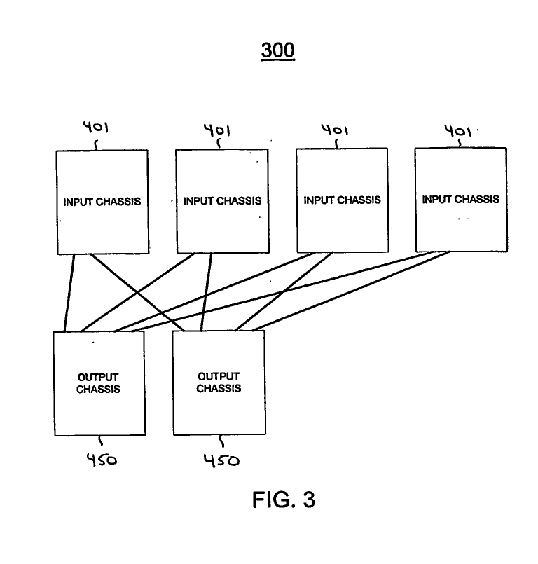

FIG. 2 is a diagram illustrating a broadcast router architecture 200 that is configured with the same number of inputs and outputs, according to an illustrative embodiment of the present invention. FIG. 3 is a diagram illustrating a broadcast router architecture 300 that is configured with many more inputs than outputs, according to another illustrative embodiment of the present invention. FIG. 4 is a diagram illustrating a broadcast router architecture 500 that is configured with many more outputs than inputs, according to yet another illustrative embodiment of the present invention. Each of the input chassis 401 shown in FIGS. 2-4 includes input cards (and an expansion card (not shown) and optionally a control card), but does not include any output cards. Each of the output chassis 450 shown in FIGS. 2-4 includes output cards (and a matrix card (not shown) and optionally a control card), but does not include any input cards.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

1. A broadcast router, comprising:
at least one input chassis, each having a plurality of input cards (410) and an expansion card, the plurality of input cards for initially receiving data into the broadcast router, and the expansion card for respectively receiving the data from the plurality of input cards and arranging the data for transfer within the broadcast router; and
at least one output chassis, each having a matrix card and a plurality of output cards, the matrix card for receiving the data from all of the at least one input chassis and for routing the data to appropriate ones of the plurality of output cards, and the plurality of output cards for respectively receiving the data from the matrix card and for outputting the data external to the broadcast router,
wherein each of the at least one input chassis is without any output cards including the plurality of output cards, and each of the at least one output chassis is without any input cards including the plurality of input cards.

2. The broadcast router of claim 1, wherein a number of inputs to the at least one input chassis is different than a number of outputs from the at least one output chassis.

3. The broadcast router of claim 1, further comprising a control card, disposed in at least one of the at least one input chassis and the at least one output chassis, for providing support protocols to change input/output assignments of the data.

4. The broadcast router of claim 1, wherein the expansion card provides support protocols to change input/output assignments of the data.

5. The broadcast router of claim 1, wherein the matrix card provides support protocols to change input/output assignments of the data.

6. The broadcast router of claim 1, wherein the plurality of input cards condition the data subsequent to an initial receipt thereof.

7. The broadcast router of claim 1, wherein the expansion card arranges the data using time division multiplexing.

8. The broadcast router of claim 1, wherein the matrix card conditions the data prior to outputting the data external to the broadcast router.

9. A broadcast router, comprising:
at least one input chassis, each having a plurality of input cards and an expansion card, the plurality of input cards for receiving and conditioning data, and the expansion card for respectively receiving the data from the plurality of input cards and arranging the data using time division multiplexing for transfer within the broadcast router;
at least one output chassis, each having a matrix card and a plurality of output cards, the matrix card for receiving the data from all of the at least one input chassis and for routing the data to appropriate ones of the plurality of output cards, and the plurality of output cards for respectively receiving the data from the matrix card and for outputting the data external to the broadcast router; and
a control card, disposed within at least one of the at least one input chassis and the at least one output chassis, for providing support protocols to change input/output assignments of the data,
wherein a number of inputs to the input chassis is different than a number of outputs from the output chassis, each of the at least one input chassis is without any output cards including the plurality of output cards, and each of the at least one output chassis is without any input cards including the plurality of input cards.

10. The broadcast router of claim 9, wherein the matrix card conditions the data prior to outputting the data external to the broadcast router.
